(19) United States
(12) Patent Application Publication
(10) Pub. No.: US 2010/0039821 A1
(43) Pub. Date: Feb. 18, 2010

(54) ILLUMINATION SYSTEM

(75) Inventor: Do Suk OH, Gyeonggi-do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/240,181

(22) Filed: Sep. 29, 2008

(30) Foreign Application Priority Data
Aug. 13, 2008 (KR) 10-2008-0079485

(51) Int. Cl. F21V 29/00; F21S 6/00

(52) U.S. Cl. 362/294; 362/257

(57) ABSTRACT

The present invention provides an LED illumination system including a case having a receiving space; a light source positioned in the receiving space; and a diffusion plate coupled to both sides of the case by upward protruding and bending both ends.

### CROSS-REFERENCE TO RELATED APPLICATIONS

This application claims the benefit of Korean Patent Application No. 10-2008-0079485 filed with the Korea Intellectual Property Office on Aug. 13, 2008, the disclosure of which is incorporated herein by reference.

### BACKGROUND OF THE INVENTION

1. Field of the Invention

The present invention relates to an illumination system; and, more particularly, to an illumination system including a diffusion plate coupled to both sides of a case by upward protruding and bending both ends of the diffusion plate.

2. Description of the Related Art

Generally, an incandescent lamp and a fluorescent lamp are widely used as an illumination system. The incandescent lamp typically includes a filament formed by helically twisting a tungsten alloy to emit light by heating the filament through an electric current to a high temperature.

And, the fluorescent lamp which is further improved in comparison with the incandescent lamp using the heating of the filament uses electric discharge at a high voltage. In the fluorescent lamp, an argon gas is filled in a vacuum glass tube to facilitate discharge with a small quantity of mercury vapor and electrodes are attached to both ends of the vacuum glass tube. When a high voltage is applied between the electrodes, discharge generates to emit light.

Meanwhile, the incandescent lamp has a disadvantage of consuming much power when turned on for a long time. Accordingly, it is not economical to use the incandescent lamp inside a building or the like where it is needed to turn on the lamp for a long time, however, it is advantageous to use the incandescent lamp in a place such as a bathroom where the lamp is frequently turned on and off.

Meanwhile, because when the life of the fluorescent lamp completes its span, the discharge does not generate very well, a user feels the intense flicker. The fluorescent lamp flickers intensively when turned on because a glow lamp does not function. The light wavers or flickers while the periphery of the fluorescent lamp becomes black because the life of the lamp has completed its span. As a consequence, eye's fatigue is serious.

And, an LED(Light Emitting Diode) recently used for illumination emits light when an electric field is applied to a P-N junction unit of a diode and so a current flows. The LED is a kind of electro-luminescence in which a solid emits light through the electric field and has advantages of increasing a speed for turning on or off, reducing power consumption, extending a lifetime, emitting light with various colors, and reducing glare in comparison with other light sources for illumination.

Therefore, recently, the use of office and home illumination systems using the LED has been gradually increased.

FIG.1 is a cross-sectional view illustrating a conventional illumination system using an LED.

Referring to FIG.1, a conventional illumination system 10 using an LED includes a case 11, a power supply 12 provided on the case 11, the LED 13 provided inside the case 11 as a light source, a diffusion plate 14 coupled to the case 11, and a coupling member 15 coupling the case 11 and the diffusion plate 14.

At this time, the diffusion plate 14 is designed to be positioned on the same plane as a ceiling surface of a mounting space 17 and therefore the intensity of light traveling toward a bottom is high and the intensity of light traveling toward sides is low, whereby the brightness of an interior space is very low in comparison with the light emitting efficiency of the LED 13.

### SUMMARY OF THE INVENTION

The present invention has been invented in order to overcome the above-described problems and it is, therefore, an object of the present invention to provide an illumination system capable of increasing an emission area of light emitted to sides by including a diffusion plate coupled to a lower part of a case by upward protruding and bending both ends of the diffusion plate.

The object of the present invention can be achieved by providing an illumination system including a case having a receiving space; a light source positioned in the receiving space; and a diffusion plate coupled to both sides of the case by upward protruding and bending both ends.

Further, the light source may be an LED.

Further, a heat discharge plate may be further provided on one surface of the receiving space of the case.

Further, the case may be laid inside an installation space and the diffusion plate coupled to the case may be protruded outside the installation space.

Further, the diffusion plate may be made of transparent or opaque acrylic resin.

Further, the diffusion plate is closely coupled to the both sides of the case by bending the both ends and may be fixed by a fixing member.

Further, the fixing member may be made of an elastic body.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional illumination system using an LED; and

FIG. 2 is a cross-sectional view illustrating an illumination system in accordance with an embodiment of the present invention.

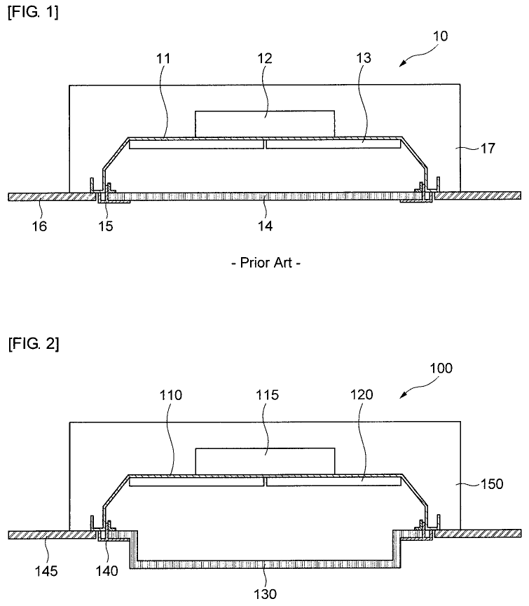

### DETAILED DESCRIPTION OF THE PREFERABLE EMBODIMENTS

Hereinafter, a matter regarding to the operation effect including the technical construction for an illumination system in accordance with the present invention will be clearly appreciated through the following detailed description with reference to the accompanying drawings illustrating a preferable embodiment of the present invention.

An illumination system in accordance with the embodiment of the present invention will be described in detail with reference to FIG. 2.

FIG. 2 is a cross-sectional view illustrating the illumination system in accordance with the embodiment of the present invention.

Referring to FIG. 2, in accordance with the embodiment of the present invention, the illumination system 100 includes a case 110, a light source 120, and a diffusion plate 130.

The case 110 has a receiving space in which the light source 120 is positioned and may have the same or a similar structure as/to that of a case used for a conventional illumination system. The design of the case 110 including a configuration and a shape may be modified variously.

At this time, the case 110 protects the light source 120 against an external environment and may be made of material such as aluminum.

And, a power supply unit 115 is further installed on a top surface of the case 110. The power supply unit 115 supplies drive power to the light source 120 by including an external power source such as a connector.

An LED is used as the light source 120 which generates light by being positioned in the receiving space of the case 110 and in general, a GaN based LED is used.

Further, a circuit board(not shown) is provided on the receiving space of the case 110 to apply or interrupt the power to the light source 120 by being connected to the light source 120 and the power supply unit 115. The circuit board is attached to one surface inside the case 110, wherein the circuit board is preferably mounted onto a surface onto which the light source 120 is attached not to be influenced by emission of the light source 120.

Further, a heat discharge plate(not shown) is provided on one surface of the receiving space of the case 110 to discharge heat generated from the light source 120 to the receiving space of the case 110, thereby increasing heat discharge effect.

Further, the diffusion plate 130 is coupled to a lower part of the case 110 to guide and diffuse the light emitted from the light source 120 in a predetermined direction and installed by being protruded outside an installation space 150.

Both ends of the diffusion plate 130 are upward protruded and bent and the both bent ends are suspended and fixed to a ceiling surface 145 and closely coupled to both sides of the case 110 by inserting a portion of the both ends into the installation space 150.

At this time, the diffusion plate 130 is preferably made of transparent or opaque acrylic synthetic resin in consideration of intensity, durability, waterproof, dampproof as well as reflexibility, transmissivity, and diffusion.

In accordance with the embodiment of the present invention, the emission area of light of the light source 120 is expanded to the sides as well as the bottom of the interior space by protruding the diffusion plate 130.

At this time, because a portion of the light emitted to the sides travels toward the interior space and another portion of the light is reflected at the ceiling surface 145 of the installation space to travel toward the interior space, light emitting efficiency is improved, thereby illuminating the interior space brightly.

And, a fixing member 140 is provided on a position on which the case 110 and the diffusion plate 130 are coupled to firm a coupling structure by closely adhering the both sides of the case 110 and the both ends of the diffusion plate 130.

At this time, the fixing member 140 is made of an elastic body to elastically press the coupling region of the case 110 and the diffusion plate 130. As shown in FIG. 2, the fixing member is elastically coupled among the both sides of the case 110, the both ends of the diffusion plate 130 and the ceiling surface 145 or may be formed in a “U” shape to wrap the both sides of the case 110 and the both ends of the diffusion plate 130. That is, the fixing member 140 may be modified in a variety of shapes without limiting to this.

Accordingly, when the power is applied to the illumination system 100 in accordance with the present invention by a user, the light source 120 installed on the circuit board primarily reflects the light from the installation space 150 to the protruded diffusion plate 130 and the diffusion plate 130 guides the reflected light in the predetermined direction to expand the emission area of the light to the bottom and the sides of the interior space, thereby illuminating the interior space brightly.

And, as a result of measuring the relative illuminance of the illumination system 100 of the present invention, a relative illuminance ratio is similar to a recommended relative illuminance ratio of the interior space, that is, a bottom 1.0: a wall 0.5-0.8: a ceiling 0.3-0.9, thereby implementing a pleasant and stable illumination environment.

As described above, the illumination system in accordance with the present invention is capable of expanding the emission area of the light emitted to the sides by including the diffusion plate coupled to the both sides of the case by upward protruding and bending the both ends of the diffusion plate, thereby improving brightness of the interior space.

Accordingly, the illumination system is capable of implementing the pleasant and stable illumination environment.

As described above, although the preferable embodiment of the present invention has been shown and described, it will be appreciated by those skilled in the art that substitutions, modifications and changes may be made in this embodiment without departing from the principles and spirit of the general inventive concept, the scope of which is defined in the appended claims and their equivalents.

What is claimed is:

1. An illumination system comprising:
a case including a receiving space;
a light source positioned in the receiving space of the case; and
a diffusion plate coupled to both sides of the case by upward protruding and bending both ends.

2. The illumination system according to claim 1, wherein the light source is an LED.

3. The illumination system according to claim 1, further comprising:
a heat discharge plate on one surface of the receiving space of the case.

4. The illumination system according to claim 1, wherein the case is laid inside an installation space and the diffusion plate coupled to the case is protruded outside the installation space.

5. The illumination system according to claim 1, wherein the diffusion plate is made of transparent or opaque acrylic resin.

6. The illumination system according to claim 1, wherein the diffusion plate is closely coupled to the both sides of the case by bending the both ends and fixed through a fixing member.

7. The illumination system according to claim 6, wherein the fixing member is made of an elastic body.
